(19) United States
(12) Patent Application Publication
(10) Pub. No.: US 2026/0112931 A1
(43) Pub. Date: Apr. 23, 2026

(54) Aircraft motor

(71) Applicant: Changzhou Taifei Electric Co., Ltd., Changzhou (CN)

(72) Inventor: Tianfeng Wu, Changzhou (CN)

(21) Appl. No.: 19/365,657

(22) Filed: Oct. 22, 2025

(51) Int. Cl. H02K 3/04; B64D 27/30; H02K 3/02; H02K 3/30; H02K 3/46; H02K 5/15

(52) U.S. Cl. CPC H02K 3/04; H02K 3/02; H02K 3/30; H02K 3/46; H02K 5/15; B64D 27/30

(57) ABSTRACT

An aircraft motor includes a front end cover, a rear end cover, a housing, a stator assembly, and a rotor assembly, where the stator assembly is fixedly connected in the housing in an insulated manner, one end of the rotor assembly is rotatably connected to the rear end cover in a supported manner, and the other end of the rotor assembly is rotatably connected to the front end cover; and the front end cover and the rear end cover are fixed to a front portion and a rear portion of the housing. The stator assembly includes a stator coil winding, an insulating varnish, and a structural adhesive, where the stator coil winding is a self-supporting stator coil winding, the insulating varnish is configured to achieve insulation of the stator coil winding, and the structural adhesive is configured for the stator coil winding to be formed into a fixed shape.

### TECHNICAL FIELD

The present disclosure belongs to the technical field of electrified aircraft propulsion, and particularly relates to an aircraft motor.

### BACKGROUND

Driven by technological advancement and pursuit of sustainable development concepts, electrification of transportation vehicles has become a mainstream development trend. For aircraft, electrification of propulsion devices serves as a foundation for full electrification of the entire aircraft industry.

The present disclosure is a continuation and an integral part of a preceding invention, rather than a provisional patent claim. In the preceding patent application Ser. No. 18/429,672 2490075THBS2 filed by the Company, an electrified propulsion device employs a multi-motor array driving a gear reduction mechanism in parallel to output power, which potentially enhances the overall safety of the electric driving device: 1. power redundancy resulting from parallel operation of a plurality of motors; 2. power transmission safety from the gear reduction mechanism that acts as a buffer between the plurality of motors and high-speed rotating components (such as a propeller or a fan); 3. electrical safety achieved by operation of the plurality of motors at lower current loads; and 4. use of mature and reliable radial-flux permanent-magnet inner rotor motors, thereby preventing instability risks associated with force-induced deformation that commonly occurs during operation of an axial-flux motor.

The aircraft is a high-risk transportation vehicle, and safety is the top priority. On the basis of enhancing the safety performance of a power unit, an electric motor, as a core assembly of the electrified propulsion device of the aircraft, should also exhibit high efficiency.

High efficiency and lightweight (i.e., a high power density) are everlasting goals for aircraft propulsion motors, and a preferred solution for achieving these goals is to increase a rotational speed of the motor. Specifically, since power equals a torque multiplied by a rotational speed, a higher rotational speed requires a lower torque for the same power output, and a volume/weight is smaller. Increasing the rotational speed of the propulsion motor may increase power, and further enhance the dynamic performance of the aircraft, or reduce a motor volume and improve a power density and a material utilization rate when the same power and dynamic performance are maintained. The most direct advantages include a reduction in the weight and use cost of the aircraft, and better agility and maximum speed performance of the aircraft at a limited electricity consumption level.

### SUMMARY

The present disclosure provides an aircraft propulsion motor. The main technical solutions employed are as follows:

I. Replacement of a Copper Wire with an Aluminum Wire

The aircraft propulsion motor is required to meet the lightweight requirements to improve economy. A density of an aluminum wire is approximately one third of a density of a copper wire. At the same current load, employing the aluminum wire for a stator coil winding may reduce the weight by over 30%, and lower the material cost.

### II. Coreless Stator Design

An iron-core motor exhibits a core loss (an eddy current and a hysteresis loss), thereby leading to reduced efficiency and temperature rise in a high-frequency state. As the aircraft propulsion motor is required to operate in an environment with a large temperature difference and high vibration, the coreless stator design eliminates heat generation from the iron loss, reduces a motor weight, and enhances a power density.

### III. High-Frequency, Low-Resistance Winding Design

The stator winding is made of either a plurality of strands of Litz wires (the total number of strands in a coil is greater than or equal to 50) or multi-layer aluminum sheets (with a cross-sectional aspect ratio of greater than 1:5). This design suppresses a skin effect and a proximity effect generated by a high-frequency current in the coil, thereby reducing a high-frequency alternating current (AC) resistance and minimizing heat generation.

### IV. Application of Ceramic Bearings

The aircraft motor is required to operate at a high speed and a high frequency variation in an environment with a large temperature difference. Ceramic bearings meet these scenario requirements, reduce the weight, eliminate electrical erosion, and mitigate risks of lubrication failure.

### V. Hollowed-Out Housing Design

The aircraft motor design needs to balance heat dissipation, a high power density, and a lightweight. An enclosed housing results in low heat dissipation efficiency, and tends to operational overheating that may compromise the insulation life of the coil. A hollowed-out structure increases a contact area between the winding coil and a coolant, enhances the heat dissipation capability of the coil, and reduces the overall weight of the motor.

### VI. Hollow Rotor Shaft Design

A rotor shaft of the aircraft motor needs to meet the requirements of weight reduction and heat dissipation while ensuring a power output. In addition to reducing the weight, the hollow shaft design has additional internal surface areas for contact with the coolant, thereby facilitating heat dissipation from an interior of the motor.

The present disclosure has the beneficial effects of: 1. reducing heat generation and providing efficient heat dissipation; 2. reducing the weight and enhancing the reliability; 3. improving the efficiency of electrical energy conversion; and 4. increasing a rotational speed of a rotor assembly.

### BRIEF DESCRIPTION OF THE DRAWINGS

In order to explain the embodiments or technical solutions of the present disclosure more clearly, the drawings to be used in the embodiments or the prior art will be briefly introduced below.

FIG. 1 is an overall external view of an aircraft motor according to the present disclosure.

FIG. 2 is a structural view of a stator coil winding made of Litz wires.

FIG. 3 is a structural view of a stator coil winding made of multi-layer metal sheets.

FIG. 4 is a schematic structural view of a stator coil winding, where A is a front view of a coil motor at a rear end of a motor, and B is a side view of a stator coil.

FIG. 5 is a schematic exploded view of an aircraft motor according to the present disclosure.

Reference numerals in the figures: 101—rear end cover; 102—housing; 103—stator assembly; 104—rotor assembly; 105—spacer ring; 106—bearing; 107—front end cover; and 108—bolt.

### DETAILED DESCRIPTIONS OF THE EMBODIMENTS

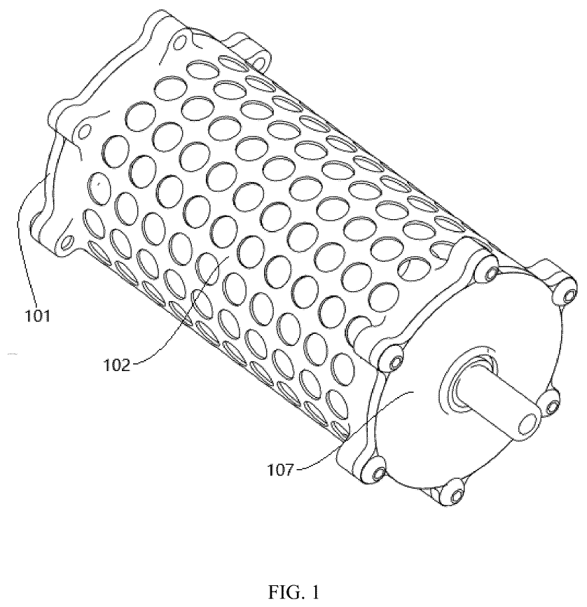

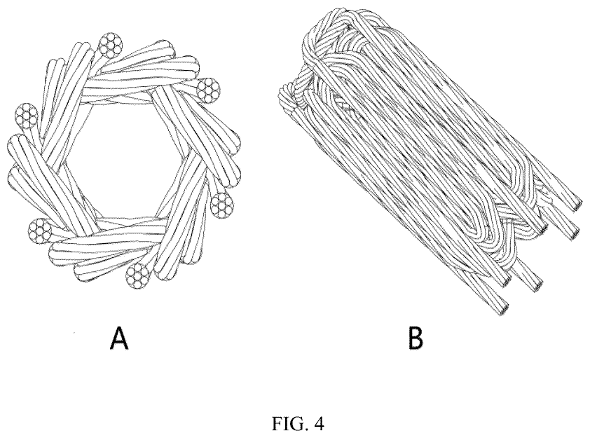

As shown in FIGS. 1, 4, and 5, an aircraft motor includes a front end cover 107, a rear end cover 101, a housing 102, a stator assembly 103, a rotor assembly 104, spacer rings 105, bearings 106, and bolts 108. The stator assembly 103 is fixedly connected in the housing 102 in an insulated manner, one end of the rotor assembly 104 penetrates through the stator assembly 103 and is connected to the bearing 106 (not shown) mounted in the rear end cover 101 in a supported manner, and the other end of the rotor assembly 104 is connected to the bearing 106 mounted in the front end cover 107 in a supported manner; and the front end cover 107 and the rear end cover 101 are fixed to a front portion and a rear portion of the housing 102 through the bolts 108, respectively; where the stator assembly 103 is of a coreless stator structure, and the stator assembly 103 includes a stator coil winding, and the stator coil winding is a self-supporting stator coil winding.

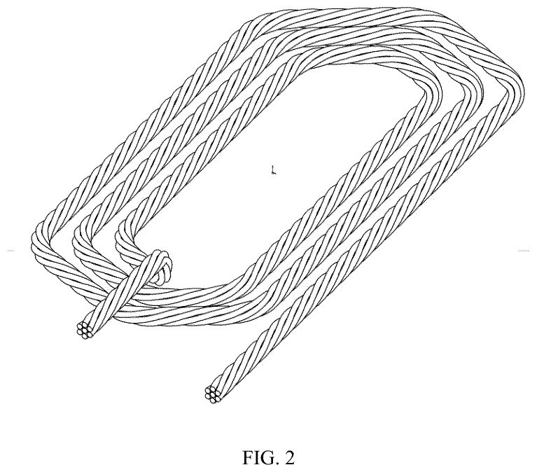

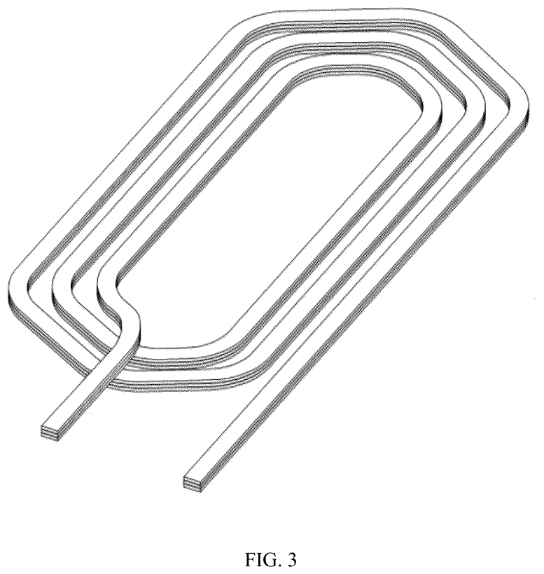

As shown in FIGS. 2 to 4, the stator assembly 103 further includes an insulating varnish and a structural adhesive, the stator coil winding is made of an aluminum material, the insulating varnish is configured to achieve insulation of the stator coil winding, the structural adhesive is configured to enable the stator coil winding to be formed into a fixed shape and fix the state coil winding to the housing 102, and the stator coil winding is formed by winding the Litz wires or multi-layer sheets.

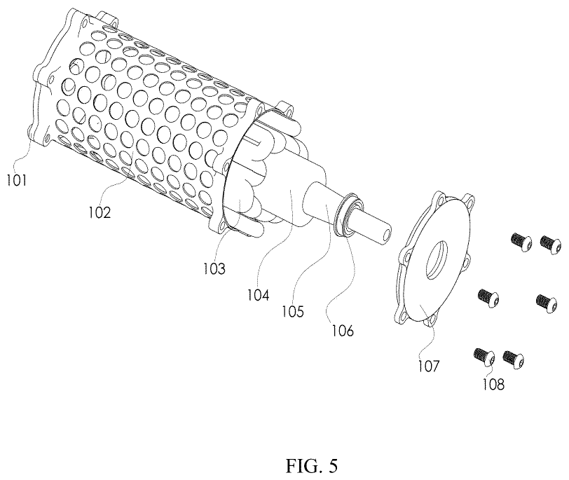

As shown in FIG. 5, the rotor assembly 104 includes a rotor shaft, permanent magnets, and spacer rings 105, where the rotor shaft is a hollow shaft, the spacer rings 105 are disposed between the shaft and the front and rear bearings (the rear spacer ring and rear bearing are not shown) and configured to maintain axial dimensional positioning of the rotor shaft in the stator assembly 103, and the bearings 106 are ceramic bearings. Moreover, the housing 102 is designed with a hollowed-out external surface.

The advantages of the present disclosure are manifested in the following aspects:

I. During high-speed/high-frequency operation of the motor, the stator winding exhibits a significant skin effect and a significant proximity effect, which are collectively called a winding eddy current loss. In view of different basic physical properties (a density resistivity, a thermal conductivity, and a thermal expansivity) of the aluminum material and a copper material, since an electrical resistivity (2.65×10⁻⁸ Ω·m) of the aluminum material is higher than an electrical resistivity (1.68×10⁻⁸ Ω·m) of the copper material under the same current load conditions, an aluminum wire with a 1.7-fold cross-sectional area is employed to replace a copper wire. By utilizing the aluminum wire with a 1.7-fold cross-sectional area for the stator coil winding, the following beneficial effects are achieved:

1. Weight advantage: A density of aluminum (2.7 g/cm³) is only 33% a density of copper. After the cross-sectional area is increased by 1.7-fold, a volume increases by 1.7-fold, but a mass of the aluminum is only 52% a mass of the copper, such that nearly half a weight is reduced. This reduction is crucial to the high-frequency motor: A lightweight lowers a motor inertia, enhances a rotational speed stability, and reduces a mechanical loss, vibration, and noise.

2. After the cross-sectional area of the aluminum wire is increased, both a direct current (DC) resistance and an AC resistance are significantly reduced. Calculations based on a skin depth formula indicate that a skin depth of aluminum is greater than a skin depth of copper, a current distribution is more uniform at a high frequency, the skin effect is weak, and less heat is generated.

3. Owing to a greater skin depth and a more uniform current distribution of the aluminum wire, the magnetic field coupling between adjacent conductors is weak, and less heat is generated from the proximity effect compared to the copper wire.

4. The copper wire has a superior thermal conductivity, but a surface area of the aluminum wire is increased by increasing the cross-sectional area (a 1.7-fold design), which accelerates heat diffusion, and enables more effective heat dissipation.

5. The copper wire exhibits a better thermal expansivity. However, high-frequency heat generation is reduced for the aluminum wire with an increased cross-sectional area, such that small thermal deformation and low thermal stress are generated in the coil, mechanical stress induced by thermal expansion is reduced, and the service life and stability of the motor are enhanced.

In summary, the aluminum Litz wire with a 1.7-fold cross-sectional area is used for the stator coil in the high-frequency motor, high performance and cost optimization may be achieved through optimized thermal management, weight reduction, efficient spatial utilization, and superior performance regarding the skin effect and proximity effect, and this design is more suitable for the electrified aircraft propulsion field demanding a high rotational speed (a high frequency), a high power density, and a lightweight.

II. An electric aircraft requires a high power output in a limited space. A conventional iron-core motor suffers from deficiencies such as a large volume, a large weight, a magnetic saturation, and a core loss, thereby leading to a sharp efficiency drop at a high frequency. This design eliminates a core loss in the stator, such as torque ripple, cogging, stator hysteresis, and an eddy current, and the motor becomes light, compact, quiet, and efficient, thereby enhancing the efficiency. The core advantages of a coreless design are as follows:

1. High mechanical reliability: A coreless structure ensures a uniform stress distribution, and enables the motor to withstand a large vibration load and better comply with the requirements of airworthiness standards.

2. Ultimate lightweighting and high power density: The coreless design allows the winding to directly fit with an inner surface of the housing, thereby eliminating redundant materials. The coreless design meets the future demand of the aircraft for a motor power density exceeding 20 kW/kg.

3. Breakthroughs in high-frequency efficiency and thermal management: High-frequency operation capability: The coreless design allows the motor to operate at an MHz-level frequency due to absence of a core loss; high-performance heat dissipation: Without a core acting as a thermal barrier, the stator winding directly fits with the inner surface of the hollowed-out housing, such that direct liquid-cooling heat dissipation becomes a preferred option.

The properties of the motor with a coreless stator design, such as high stability, high reliability, and efficient energy conversion, enable the motor to become a preferred choice for an electrified aircraft propulsion system and an aircraft electrification process.

III. The core benefits of utilizing ceramic bearings in the high-speed aircraft propulsion motor are mainly manifested in safety, high performance, and lightweight aspects:

### 1. Safety Manifested by Chemical and Electrical Corrosion Resistance, and Long Service Life

The ceramic bearings exhibit strong chemical inertness, and operate stably under operating conditions such as oil and grease vapor, salt spray, and ultraviolet exposure. With an electrical resistivity of greater than 10¹² Ω·m, the ceramic bearings have excellent insulation and protection against electrical erosion. Electrical corrosion generated by arcing discharge caused by electric current passage through the bearings is effectively prevented, and thus bearing failure is prevented.

Due to the basic physical properties of ceramics, such as a thermal conductivity (10-15 W/m·K) and a coefficient of thermal expansion (e.g., 5.5×10⁻⁶/C° for Al₂O₃), a low thermal conductivity is excellent, such that loss of precision caused by bearing deformation at a high temperature is prevented, the reliable operating time of the motor is extended, and maintenance requirements are reduced.

### 2. High Performance Demonstrated by a High Speed and Reduced Wear

Ceramics have a hardness (HV 2,000-3,000) more than 5 times greater than a hardness of steel, and exhibit excellent high-temperature resistance and thermal stability. A limiting speed of the ceramic bearing may reach 1.3 times a limiting speed of a steel bearing of the same model. Due to the properties of a ceramic material, a low friction coefficient and a self-lubricating characteristic significantly reduce frictional heating, and a wear rate under a high-speed operating condition is extremely low.

### 3. Ultimate Lightweighting Performance

With an obvious material density advantage, the ceramic bearing (such as Si₃N⁴ and Al₂O³) has a density of 3.2-4.0 g/cm³, and contributes to aircraft weight reduction by approximately 50% compared with the conventional steel bearing.

IV. A hollowed-out design of the housing and a hollow structure of the rotor shaft are mainly intended to create conditions for heat dissipation and to reduce the weight of the motor. The specific advantages are as follows:

### A. Advantages of the Hollowed-Out Design of the Housing:

1. Significant weight reduction: Through topological optimization, the hollowed-out design reduces a housing weight by over 30%, directly enhances a power density of the aircraft, and maintains a static strength.

2. Enhanced heat dispersion and improved convection: The hollowed-out structure increases a surface area available for heat dissipation. A combination of the hollowed-out structure with forced air or liquid cooling may reduce the temperature rise by above 20%-30%. The open design allows rapid heat dissipation, alleviates thermal stress, and prevents a localized high temperature in the stator winding that may cause motor performance degradation or failure.

3. Damping effect for vibration and noise suppression: The hollowed-out structure may optimize a vibration transmission path, and reduce noise and vibration when used in conjunction with a wave-absorbing material.

### B. Advantages of the Hollow Structure of the Rotor Shaft:

1. The hollow shaft is lighter than a solid shaft, thereby resulting in a reduced rotational inertia and an improved dynamic response speed.

2. The hollow structure enhances heat dissipation by increasing an internal surface area to reduce concentration of thermal stress.

3. Micro-passages are formed in the hollow shaft to implement direct liquid cooling of the rotor, and the heat dissipation efficiency is significantly improved.

The aircraft motor necessitates a high power density and a superior heat dissipation performance, and has a high requirement for stability under extreme conditions (such as a large temperature difference and severe vibration). Integration of the above technical solutions establishes a robust hardware foundation and excellent heat dissipation conditions for the aircraft motor, thereby enabling the stable long-term operation of the motor in a liquid-cooled, enclosed device.

As a conceptual technical device based on an aircraft electrification idea, the present disclosure only elaborates on the technical solutions and structural features. Prior to detailed engineering implementation, specific application scenarios are required, and a collaborative design integrating structure, materials, and cooling will be employed. Specific design work may be carried out only when this prerequisite is satisfied.

The core innovation of the present disclosure lies in proposing a forward-looking concept that facilitates the high-speed operation and lightweight design, and creates conditions for efficient cooling. The motor designed based on this concept exhibits the characteristics of a high rotational speed, a high power density, and a lightweight. More importantly, the motor demonstrates enhanced long-term stability, greater adaptability to diverse operating conditions, and reduced maintenance requirements. Consequently, from a technological evolution perspective, the present disclosure not only sets a benchmark for the design of the electrified aircraft propulsion motor, but also reveals a significant potential for application of electrified propulsion systems in other industries.

The above descriptions are only specific embodiments of the present disclosure, but the protection scope of the present disclosure is not limited thereto. Any equivalent variations or substitutions made without making creative efforts should fall within the protection scope of the present disclosure. Therefore, the protection scope of the present disclosure is subject to the protection scope defined by the claims.

What is claimed is:

1. An aircraft motor, comprising a front end cover, a rear end cover, a housing, a stator assembly, and a rotor assembly, wherein the stator assembly is fixedly connected in the housing in an insulated manner, one end of the rotor assembly penetrates through the stator assembly and is rotatably connected to the rear end cover in a supported manner, and the other end of the rotor assembly is rotatably connected to the front end cover in a supported manner; and the front end cover and the rear end cover are fixed to a front portion and a rear portion of the housing, respectively;
wherein the stator assembly is of a coreless stator structure, and the stator assembly comprises a stator coil winding, and the stator coil winding is a self-supporting stator coil winding.

2. The aircraft motor according to claim 1, wherein the stator assembly further comprises an insulating varnish and a structural adhesive, the stator coil winding is made of an aluminum material, the insulating varnish is configured to achieve insulation of the stator coil winding, and the structural adhesive is configured to enable the stator coil winding to be formed into a fixed shape and adhesively fix the state coil winding to the housing.

3. The aircraft motor according to claim 1, wherein the stator coil winding is made of wires with a large surface area characteristic, which are not limited to Litz wires or multi-layer sheets.

4. The aircraft motor according to claim 1, wherein the rotor assembly comprises a rotor shaft and permanent magnets, and the rotor shaft is a hollow shaft.

5. The aircraft motor according to claim 4, wherein the rotor shaft is connected to the front end cover and the rear end cover through bearings, and the bearings are ceramic bearings.

6. The aircraft motor according to claim 1, wherein the housing is a hollowed-out housing.
